(19) United States
(12) Patent Application Publication
(10) Pub. No.: US 2010/0296679 A1
(43) Pub. Date: Nov. 25, 2010

(54) METHOD FOR ACCLIMATIZING A PROGRAMMABLE HEARING DEVICE AND ASSOCIATED HEARING DEVICE

(75) Inventors: Marc Hofmann, Nurnberg (DE); Christoph Konrad Schmid, Schwabmunchen (DE); Michael Sieber, Furth (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/783,103

(22) Filed: May 19, 2010

(30) Foreign Application Priority Data
May 19, 2009 (DE) 10 2009 021 855.6

(51) Int. Cl. H04R 25/00

(52) U.S. Cl. 381/316

(57) ABSTRACT

A method provides time-dependent automatic acclimatization of at least one parameter of a hearing device, for example the volume, to a predeterminable target. In the method the speed of the automatic acclimatization is influenced by parameter changes made by a wearer of the hearing device himself. Advantageously this makes it possible to address the individual familiarizing phase and requirements of the wearer of the hearing device and finally to set an optimum parameter value.

### CROSS-REFERENCE TO RELATED APPLICATION

This application claims the priority, under 35 U.S.C. §119, of German application DE 10 2009 021 855.6, filed May 19, 2009; the prior application is herewith incorporated by reference in its entirety.

### BACKGROUND OF THE INVENTION

### Field of the Invention

The invention relates to a method and to a hearing device specified for time-dependent automatic acclimatization of at least one parameter of the hearing device to a predeterminable target value.

Known hearing devices feature at least one microphone or a telephone coil for receiving an acoustic or electromagnetic input signal and converting the input signal into an electrical signal. The electrical signal is processed and is amplified as a function of the signal frequency before it is fed to an output converter for issuing an output signal. Electro-acoustic converters (receivers) are usually used as output converters. However output converters are also known which issue an output signal in the form of electrical impulses for stimulation of nerves or are connected directly to small bones in the ear and cause these to oscillate.

Hearing devices should be able to operate adapted to a specific situation as far as possible. Algorithms for improving the sound impression, the speech comprehensibility or to ensure a system behavior (e.g. feedback compensator) should only be automatically activated to an extent and become effective at a specific volume as the situation demands, since the algorithms can also exhibit a disadvantageous behavior. For example a noise reduction algorithm, a directional microphone or a feedback compensator should not be activated if the hearing aid wearer is attending a concert. In this case a noise reduction algorithm would attack the user signal and create artifacts. A directional microphone would alter the spatial sound impression in an undesired manner. A feedback compensator would create unwanted artifacts.

Furthermore there are situations in which these algorithms, although they are activated, are only intended to have a slight effect. In the final analysis the decision as to the time at which system parameter settings are to become effective so that the hearing aid is accepted as widely as possible is one that only the hearing aid wearer can make.

In a programmable hearing device the user is provided with a plurality of different sets of parameters, known as hearing programs. Parameters of a parameter set to be selected are typically amplification, number of active microphones, threshold value, response time of a compression circuit, maximum output signal level and frequency curve. Each of these parameter sets represents the sensibly matched settling of all signal processing parameters for a specific acoustic hearing or ambient situation, for example the ambient situation “speaking in a quiet environment”, i.e. without disruptive background noise, or an ambient situation “speaking in a noisy environment” with low-frequency interference noise.

The adaptation of the hearing device is generally undertaken by the audiologist measuring the characteristic data of the hearing (audiogram) for the person with impaired hearing. The level of hearing loss, the uncomfortable level, volume scaling and the like are typically regarded as characteristic audiometric data. Subsequently the individual parameter sets are defined for different hearing situations. In this first adaptation process (first fit) the emphasis is on the subjective sound perception and positive sound evaluation by the hearing aid wearer. The objective of the first fit is that the wearer of the hearing device feels that the sound is at a comfortable level. This is frequently at the expense of speech comprehension, which is thus gradually improved thereafter by the corresponding adaptation of the operating parameters. This is done either in further adaptation sessions at the audiologist or by an automatic adaptation process in the hearing device.

Published, non-prosecuted German patent application DE 195 42 961 describes a circuit for operating a hearing aid in which the operating parameter setting of the initial situation determined by the audiologist in each case as well as the target situation is defined in a memory arrangement. By use of a control unit an automatic adaptation of the operating parameters of the initial situation to the operating parameters of the target situation is carried out over a specifiable period of time. This process is referred to as acclimatization. Expediently the adaptation of the parameters is undertaken in magnitude steps and time intervals that remain the same. If the device is adapted too quickly to the target state the wearer of hearing device can select a longer time interval and make the adjustments autonomously. The disadvantage of this process is that the hearing aid wearer can only influence the time component of the adaptation process himself and all other parameters can only be changed by the audiologist during further fitting sessions.

Published, European patent application EP 1 453 357 A2, corresponding to U.S. Pat. No. 7,340,074, describes a hearing device and a method for simplifying the individual fitting of a hearing device to a hearing device wearer. The wearer of the hearing device in this case has the opportunity of setting selected operating parameters, such as the amplification for example, manually on the hearing device when he finds himself in a specific situation characteristic for him. At the same time an adjustment process is initiated in the hearing device by this hearing situation being physically measured. The measured values obtained and the manually selected operating parameter value are included to determine a new characteristic curve field. In this characteristic curve field a plurality of ambient situations are linked to corresponding values of the operating parameter value concerned. This makes it possible in a new hearing situation to automatically set a corresponding value of the operating parameter value involved. The disadvantage in this learning-based method is that the preferred settings can frequently deviate from the optimum speech comprehensibility. The hearing device learns to the benefit of the sound image but with little additional benefit in relation to the objective of optimum speech comprehensibility. The laboriously adapted fine adjustments made by the audiologist can be destroyed by this and can lead to a bad outcome.

### SUMMARY OF THE INVENTION

It is accordingly an object of the invention to provide a method for acclimatizing a programmable hearing device and an associated hearing device which overcome the above-mentioned disadvantages of the prior art methods and devices of this general type, which provides an improved method for time-dependent automatic acclimatization of at least one parameter of a hearing device to a predetermined target value.

The idea of the invention lies in the audiologist specifying the initial and target parameter set in each case for the individual hearing situations. The gradual progress of adaptation during the fitting phase is however carried out taking into account the manual adjustments of the hearing aid wearer.

If for example for a defined hearing environment a target amplification has been specified for the loudness parameter which lies 6 dB above the start amplification, an additional increase in the volume undertaken by the hearing aid wearer would lead to the time intervals of the gradual increase of the volume parameter being shortened and to the target value of this parameter being achieved more quickly. If on the other hand the user tends to set the hearing device quieter, this leads to a lengthening of the adaptation intervals as well as to a reduction of the target value for the loudness parameter.

In accordance with the invention the desired object is achieved by the method for time-dependent automatic acclimatization of at least one parameter of a hearing device to a predeterminable target value and by the hearing device for time-dependent automatic acclimatization of at least one parameter of the hearing device to a predeterminable target value.

The invention claims a method for time-dependent automatic acclimatization of at least one parameter of a hearing device, for example the volume, to a predeterminable target value. In this case the speed of the automatic acclimatization is influenced by parameter changes made by the wearer of the hearing aid himself. In an advantageous manner this makes it possible to address the individual familiarization phase and requirements of the wearer of the hearing aid and in the final analysis to set an optimum parameter value.

Preferably the method can be ended when the target value is reached by the parameter or if a predeterminable period of time has elapsed. This ensures that the target value predetermined at the start can be reached if the wearer of the hearing aid does not make any changes to parameters himself. In addition it can be ensured that the predetermined period of time for the acclimatization of the hearing device is not exceeded.

In an advantageous embodiment of the invention the parameter can be changed by a first value at predeterminable points in time. Via the first value for example a standard change of the parameter can be made at the predeterminable points in time if the wearer of the hearing device does not make any changes to the parameter. If on the other hand the wearer of the hearing device makes at least one change to the parameter, at least one second value is determined from this and the parameter is changed by at least the second value. It is likewise possible to switch off the standard change of the parameter at the predeterminable points in time by selecting the first value to be equal to zero. Therefor the progress of acclimatization is controlled solely via the second value by the changes made by the wearer of the hearing device to the parameter.

In a particular embodiment the points in time are evenly distributed over the predeterminable period of time. This enables an even acclimatization progress to be set.

In an advantageous manner the first value can be changed as a function of the predeterminable points in time or can be the same at any of the predeterminable points in time. In the event of the wearer of the hearing aid not making any changes, this allows an acclimatization plan with adaptation steps distributed evenly over the adaptation period to be implemented. The parameter is then adapted at the predetermined points in time by the first value in each case.

In a development of the method acclimatization can be carried out for different frequencies or frequency bands. This advantageously enables an individual set of frequencies for a number of frequency bands to be defined for the wearer of the hearing device at which or in which an acclimatization is carried out.

In a particular embodiment the hearing situation can be taken into account during the acclimatization. This sets the hearing device in the optimum way for definable hearing situations.

The invention also claims a hearing device for time-dependent automatic acclimatization of at least one parameter of the hearing device to a predeterminable target value. The hearing device contains an adaptation unit through which the speed of the automatic acclimatization is able to be adapted in dependence on the changes made by a wearer of the hearing device.

In a particular embodiment the hearing device can include a memory device for storing a predeterminable target value, a predeterminable period of time and predeterminable points in time. This enables the target value of the parameter as well as the period of time of the acclimatization and the points in time at which a change of the parameter by the first value is made to be individually defined.

In a particular embodiment of the invention the hearing device can include a data entry device which is connected to the memory device. This makes it possible to enter data for individual control of the acclimatization.

In a further advantageous embodiment the hearing device can include an adjustment device for the wearer of the hearing aid to change the parameter. This makes it possible for the wearer of the hearing device to make his own changes to the parameter which will be taken into account in the acclimatization period.

In a particular embodiment, the hearing device can be a hearing aid.

Other features which are considered as characteristic for the invention are set forth in the appended claims.

Although the invention is illustrated and described herein as embodied in a method for acclimatizing a programmable hearing device and an associated hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a flowchart of a method for time-dependent automatic acclimatization according to the invention;

FIG. 2 is a block diagram of a hearing device for time-dependent automatic acclimatization; and

FIG. 3 is a diagram of the change of the parameter in an acclimatization period.

### DETAILED DESCRIPTION OF THE INVENTION

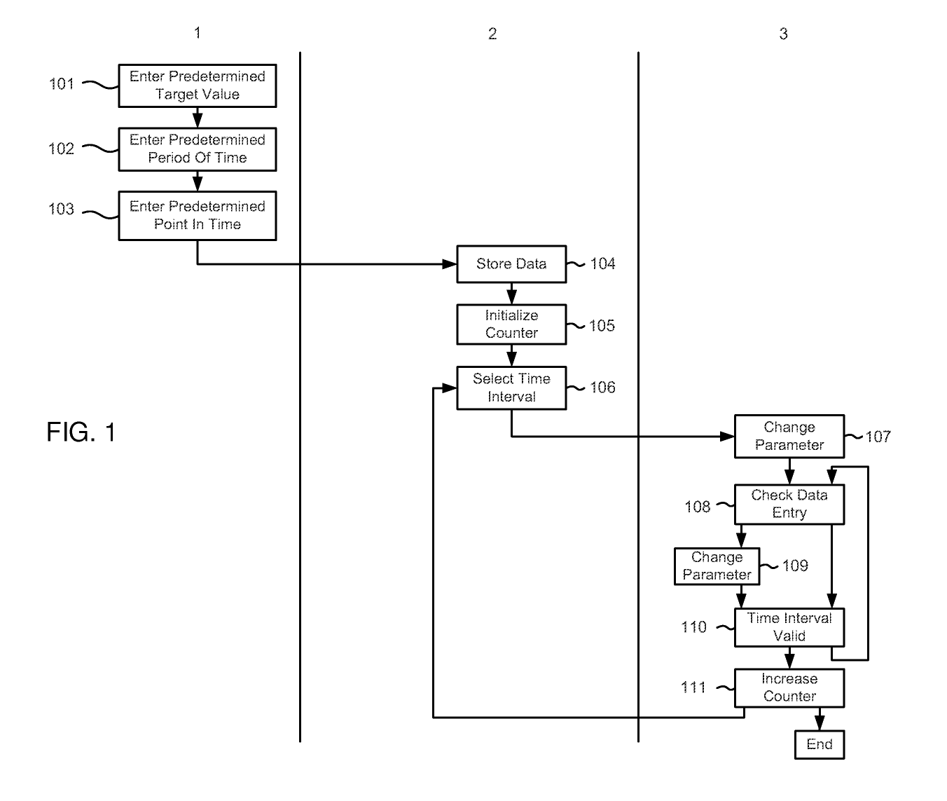

Referring now to the figures of the drawing in detail and first, particularly, to FIG. 1 thereof, there is shown a flowchart of an inventive method of time-dependent automatic acclimatization of a least one parameter of a hearing device to a predeterminable target value. In step 101a predeterminable target value, in step 102 a predeterminable period of time and also in step 103 at least one predeterminable point in time are entered into a data entry device 1. In method step 104 the data entered with the data entry device 1 is stored in a memory device 2. In the step 105 a counter value n is initialized with 1. In step 106 the current observed time interval [point in time n; point in time n+1] (abbreviated below to [ZPₙ; ZPₙ₊₁]) is selected using the counter value n. In step 107 in the adaptation unit 3 for the currently observed time interval [ZPₙ; ZPₙ₊₁] the parameter is changed by the first value. Subsequently in step 108 in the adaptation unit 3 a data entry from the adjustment device 4 is checked. If a data entry from the selection device 4 is present then in step 109 the parameter is changed by a further value. In step 110 a check is made as to whether the current observed time interval [ZPₙ; ZPₙ₊₁ is still valid. If it is, a branch is made back to step 108. If the currently observed time interval [ZPₙ; ZPₙ₊₁] is no longer valid, then in step 111 the counter value n is increased by 1 and the method continues with step 106. If no further time interval is present the method is ended. This method for the time-dependent automatic acclimatization can be undertaken for different frequency bands.

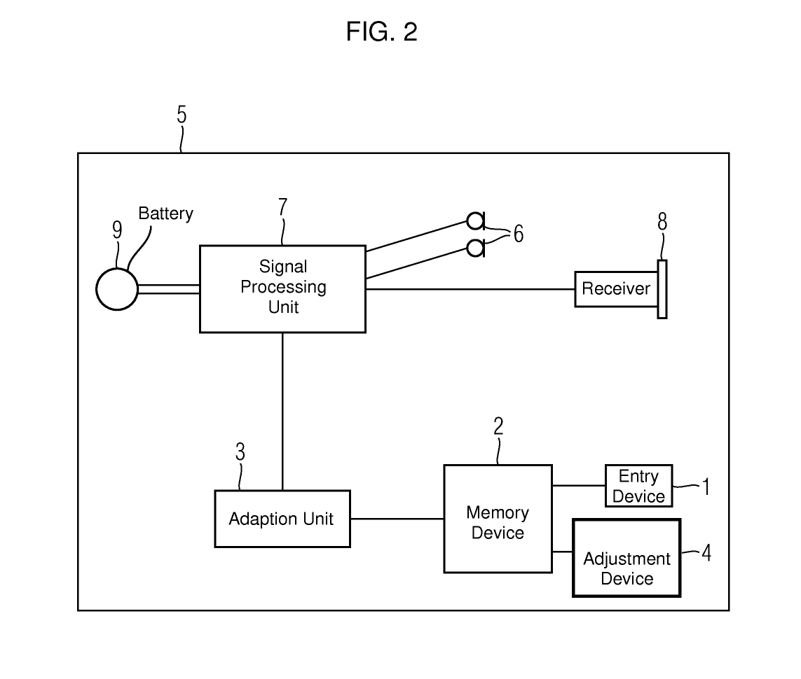

FIG. 2 shows a block diagram of a hearing device with its significant components for time-dependent automatic acclimatization of at least one parameter of a hearing device to a predeterminable target value. Since the inventive device is preferably used in hearing aids the following example is based on such a hearing aid. Built into a hearing aid housing 5 for wearing behind the ear are one or more microphones 6 for receiving the sound from the environment. A signal processing unit 7, which is likewise integrated into the hearing aid housing 5, processes the microphone signals and amplifies them. The output signal of the signal processing unit 7 is transmitted to a loudspeaker or receiver 8, which outputs an acoustic signal. The sound is transmitted if necessary to the eardrum of the device wearer via a sound tube which is fixed with an otoplastic in the auditory canal. The hearing aid, and especially the signal processing unit 7, are supplied with energy via a battery 9 likewise integrated into the hearing aid housing 5. The data entry device is connected to the memory unit 2 for transferring the data entered into the data entry device 1. The connection is preferably implemented as a wireless connection via a radio interface. The adaptation unit 3 likewise accesses the data stored in the memory device 2 via the data interface. The wearer of the hearing device can make his own settings via the adjustment device 4. The adjustment device 4 is connected to the memory unit 2. The settings made are likewise stored in the memory unit 2. The adaptation unit 3 is connected to the signal processing unit 7 and communicates the changes to be made for the parameter in the signal processing unit 7, such as loudness amplifications for example.

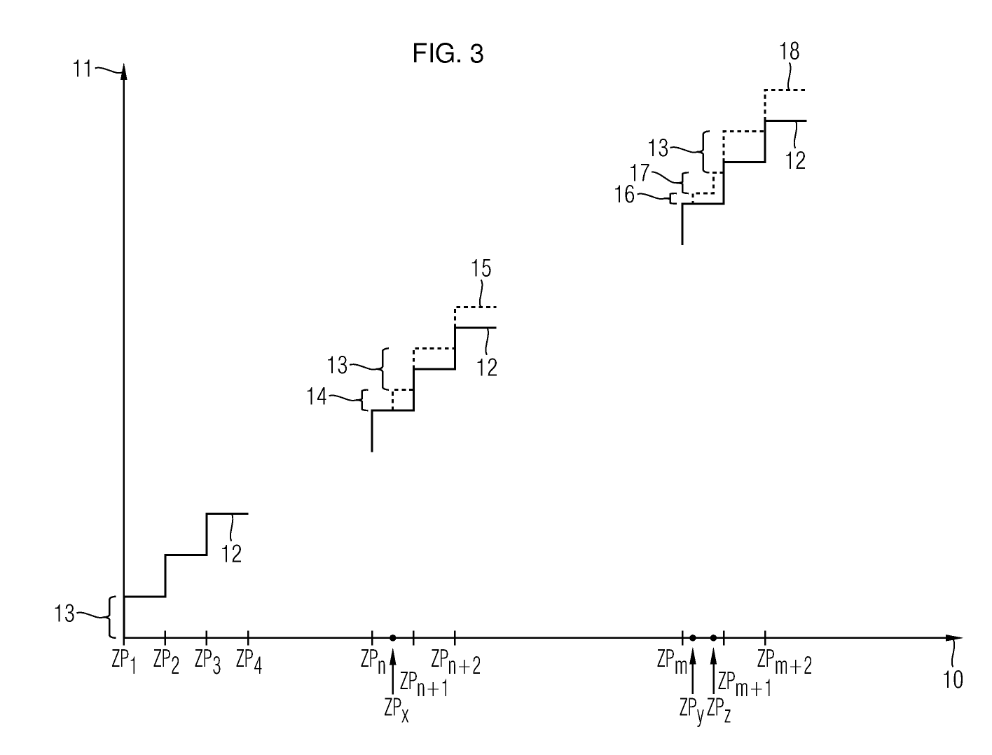

FIG. 3 shows a diagram for changing the parameter in the acclimatization period. The graph depicted shows the passage of time on the x-axis 10 and the progress of the change to the parameter on the y-axis 11. The curve 12 specifies the course of the change of the parameter in the adaptation period without the wearer making any settings. At the beginning of each new time interval the parameter is changed by a first value. For example, at the beginning of a first time interval [ZP₁; ZP₂], the parameter is incremented by the value 13. If the wearer of the hearing device now for example also makes an adjustment to the parameter in time interval [ZPₙ; ZPₙ₊₁] at the point in time tₓ indicated, this leads to an immediate change in the parameter by a second value 14 calculated by the adaptation unit 3. The curve 15 reflects the course of the change in the parameter as a result of the adjustments made by the hearing aid wearer in time interval [ZPₙ; ZPₙ₊₁]. On entry into the next time interval [ZPₙ₊₁; ZPₙ₊₂] the parameter will again be incremented by the first value 13. If the hearing aid wearer, for example in time interval [ZPₘ; ZPₘ₊₁] at the two points in time t_{y} and t_{z}, makes changes to the parameter, the adaptation unit 3, after the setting is made, at point in time t_{y} calculates a further second value 16 for the change to the parameter and, after the change at point in time t_{z}, a further second value 17 for the change to the parameter. The curve 18 reflects the course of the change in the parameter as a result of the settings by the wearer of the hearing device in time interval [ZPₘ; ZPₘ₊₁]. On entry into the next time interval [ZPₘ₊₁; ZPₘ₊₂] the parameter will again be incremented by the first value 13.

1. A method for time-dependent automatic acclimatization of a parameter of a hearing device to a predeterminable target value, which comprises the step of:
setting a speed of the time-dependent automatic acclimatization to take account of changes to the parameter made by a wearer of the hearing device.

2. The method according to claim 1, which further comprises ending the method when the parameter reaches one of the predeterminable target value and when a predeterminable period of time has elapsed.

3. The method according to claim 1, which further comprises:
changing the parameter by a first value at predeterminable points in time; and
changing the parameter by at least a second value, which is determined in each case by a change to the parameter made by the wearer of the hearing device.

4. The method according to claim 3, wherein the predeterminable points in time are equidistant.

5. The method according to claim 3, which further comprises changing the first value in dependence on a time or is a same at each point in time.

6. The method according to claim 1, which further comprises carrying out the time-dependent automatic acclimatization for different frequency bands.

7. The method according to claim 1, which further comprising taking into account a hearing situation during the time-dependent automatic acclimatization.

8. A hearing device for time-dependent automatic acclimatization of a parameter of a hearing device to a predeterminable target value, the hearing device comprising:
an adaptation unit, through which a speed of the time-dependent automatic acclimatization is able to be adapted in dependence on changes made by a wearer of the hearing device.

9. The hearing device according to claim 8, further comprising a memory device connected to said adaptation unit and storing the predeterminable target value, a predeterminable duration and predeterminable times.

10. The hearing device according to claim 8, further comprising a data entry device connected to said memory device.

11. The hearing device according to claim 8, further comprising an adjustment device to allow the hearing device wearer to make changes to the parameter.

12. The hearing device according to claim 8, wherein the hearing device is a hearing aid.
